(19) United States
(12) Patent Application Publication
(10) Pub. No.: US 2006/0123081 A1
(43) Pub. Date: Jun. 8, 2006

(54) Method and system for seamless portability by profile sharing

(75) Inventors: Daniel A. Baudino, Lake Worth, FL (US); Deepak P. Ahya, Plantation, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/004,209

(22) Filed: Dec. 3, 2004

(51) Int. Cl. G06F 15/16; G06F 15/177

(52) U.S. Cl. 709/204; 709/221

(57) ABSTRACT

A framework (10) and method (60 and 70) of collectively setting preferences among at least two electronic devices (52 and 54) can include the step of collecting user preference data independently by the at least two electronic devices, exchanging (65 and 75) the user preference data among the at least two electronic devices when such devices are within a predetermined proximity (63 and 73), forming a user profile (82) from the user data exchanged, and setting parameters (47) in at least one among the electronic devices in accordance with the user profile. The method can further include the steps of authenticating the at least two electronic devices before the step of exchanging the user preference data and registering users. The method can also further include the step of interchanging capabilities and settings among the at least two devices.

### FIELD OF THE INVENTION

This invention relates generally to portability, and more particularly to a method and system for sharing profiles to enable substantially seamless operation.

### BACKGROUND OF THE INVENTION

Seamless mobility in the contexts of today's electronic devices seem to fail to address beyond content and session handling. A personal digital assistant can synchronize its data among several computers, but each such a device typical fails to account for a user's unique preferences and habits over a different context in terms of time, location, availability of user devices or presence of other devices/user, or device capabilities.

A user of a mobile device can be engaged in various different contexts in relation to other devices or in relation to other users of devices within a proximity of the user. Although devices exist that can merely transfer data from one device to another, such devices usually fail to account for a new context or environment in which the user can be set in.

### SUMMARY OF THE INVENTION

Embodiments in accordance with the present invention can provide a means to create an enhanced universal access and experience by learning from users and their interaction with devices.

In a first embodiment of the present invention, a method of collectively setting preferences among at least two electronic devices can include the steps of collecting user preference data independently by the at least two electronic devices, exchanging the user preference data among the at least two electronic devices when such devices are within a predetermined proximity, forming a user profile from the user data exchanged, and setting parameters in at least one among the electronic devices in accordance with the user profile. User preference data can include user content preferences, user habit preferences, user source preferences, and user device feature preferences such as movie preferences, video series preferences, actor or actress preferences, movie producer preferences, movie studio preferences, volume preferences, network preferences, user taste preferences, song preferences, radio station preferences, singer preferences, band preferences, music style preferences, web site preferences, temperature preferences, alarm setting preferences, chat buddies, and email list preferences. The method can further include the steps of authenticating the at least two electronic devices before the step of exchanging the user preference data and registering users. The method can further include the step of interchanging capabilities and settings among the at least two devices. Optionally, the method can further include the step of forming a master and slave relationship among the at least two electronic devices to enable a master device among the at least two electronic devices to request and receive a profile from a slave device among the at least two electronic devices. The master device can be selected from among the electronic devices in a number of ways including determining which device collected more profiles or determining which device is in contact with a greater number of devices. These factors can be used to give a particular device greater priority over other devices in an automatic request to become a master device. With respect to the master and slave relationship, the method can further include the step of determining a difference in user preferences and settings between the master device and the slave device and sending the difference to the slave device. Note, the step of forming a user profile can include the step of creating a common virtual profile for the at least two electronic devices containing a table having information regarding which devices handle a type of information, when the information was created, where the information was stored, and what information is relevant in a current environment in view of resources available. The method can further optionally include the step of maintaining information regarding which among the at least two electronic devices contains a full version of the common virtual profile and a partial version of the common virtual profile. Further note, the step of setting parameters can include the step of setting parameters in each of the at least two electronic devices in accordance with the user profile.

In a second embodiment of the present invention, a profile manager used in an electronic device can include an interface module for abstracting data to a remaining portion of the profile manager, a device identifier coupled to the interface module that identifies a remote device and identifies data that can be shared between the electronic device and the remote device and a profile generator coupled to the device identifier for creating a user profile based on user interactions with the electronic device. The profile manager can further include a storage medium for storing the user profile including a local profile and a interchangeable profile and an update engine for detecting what needs to be updated on at least one among the electronic device and the remote device. The profile manager can further include an input device filter coupled between the device identifier and the profile generator for filtering data to match data recognizable by the electronic device and an output device filter coupled between the storage medium and update engine for filtering data to match data recognizable by the remote device. The profile manager can further include a decision engine coupled to the update engine for directing at least one among the electronic device and the remote device to alter at least one setting in accordance with the update engine. Optionally, the profile generator can create a common virtual profile for the electronic device, the remote device, and any other remote device using the common virtual profile, wherein the common virtual profile contains a table having information regarding which devices handle a type of information, when the information was created, where the information was stored, and what information is relevant in a current environment in view of resources available.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a block diagram of a seamless portability system in accordance with an embodiment of the present invention.

FIG. 2 is block diagram of a profile manager that can be used in the seamless portability system of FIG. 1 in accordance with an embodiment of the present invention.

FIG. 3 is a data flow chart illustrating a method of providing seamless portability in accordance with an embodiment of the present invention.

FIG. 4 is a flow chart illustrating a method of collectively setting preferences among at least two electronic devices by a transmitting device in accordance with an embodiment of the present invention.

FIG. 5 is a flow illustrating a method of collectively setting preferences among at least two electronic devices by a receiving device in accordance with an embodiment of the present invention.

FIG. 6 is a block diagram of a common virtual profile in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

Embodiments in accordance with the present invention enable a framework for collecting user preferences and habits within each context from multiple electronic devices used by a user. The capabilities of the device (in use) in conjunction with preferences and habit information are used to create enhanced access and experience for the user. Embodiments herein focus on collecting & sharing learning from multiple devices and using this new shared learning to enhance an overall experience on all devices and user surroundings.

The learning at each device can include a myriad of types of information including:
1. Favorite media type (per device or all devices)
2. Favorite websites
3. User Interface preferences
4. Desired Interaction Styles
5. Environment preferences
6. Earpiece/Speaker Distance-Volume Rules
7. Contacts
8. Knowledge of User Personal Data locations (server vs. other devices)
9. User Custom or frequently used profiles

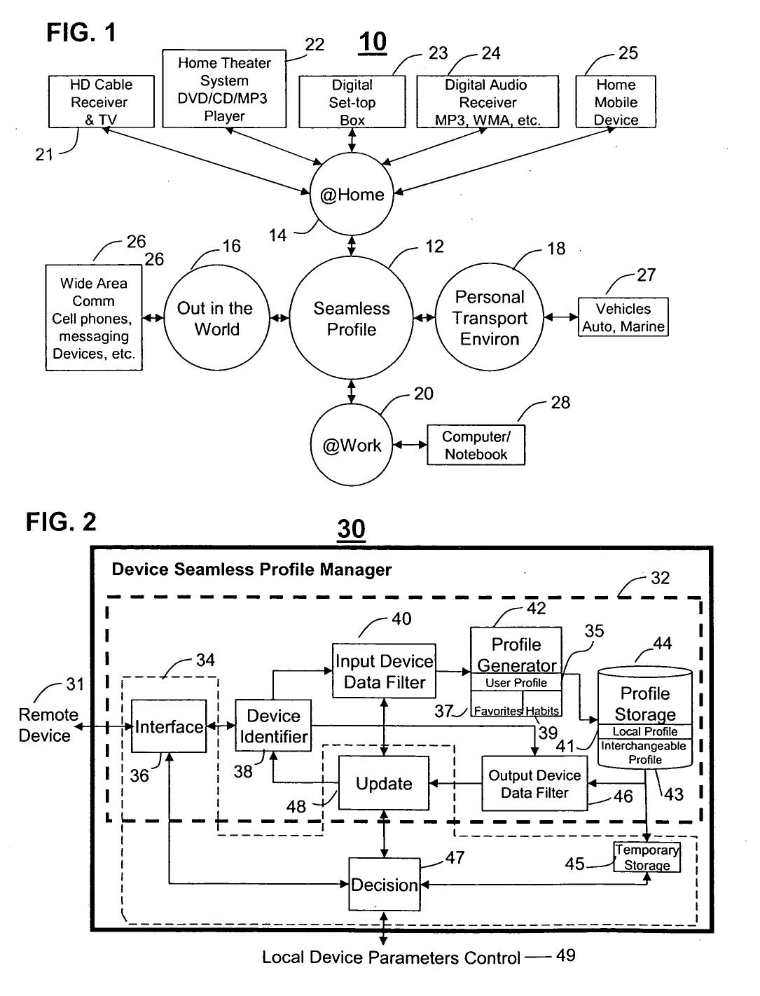

Referring to FIG. 1, a framework 10 is shown that provides “Seamless Learning Portability” among multiple user devices to work together to enhance their respective user interfaces and overall experience among several different contexts or environments. The different environments or contexts can include a home environment 14, a work environment 20, a personal transport environment 18 or an outdoor environment 16. The home environment 14 can include among a high definition (HD) receiver or television 21, a home theater system 22 having DVD or CD or MP3 players or recorders, a digital set-top box 23, a digital audio receiver 24 or a home mobile device 25 such as a remote controller or other similar device. The work environment 20 can include desktop or laptop computers 28, the outdoor environment 16 can include wide area networked communication devices 26 such as cell phones, messaging device or wireless LAN device, and the personal transport environment can include navigation systems, communication, entertainment and telematic devices 27 that might be incorporated in a vehicle. Each device can collect data over time independently from each other. When one device is in proximity of another device, the data can be exchanged between such devices over a wireless LAN or other wireless network. Such data can be stored on each device where each device stores the information that belongs to it and interchanges with other devices when requested. The parameters of the complete profile created based on the user learning can then be exchanged among similar devices creating a seamless leaming/profile exchange network 12. As noted examples above, devices providing media content such as TV's, HD cable receivers, digital set-top boxes, home theater systems can contribute to the seamless profile/learning portability aspects herein by collecting and providing a user's favorites/preferences in a list of movies, TV series etc., or a user's habits (volume, network selected, etc), or a user's preferred features (from the device), or a user's taste and watching behaviors, or a profile based on all the information collected from the user. In terms of a home theater system (CD Player, DVD Player, MP3, etc.), such devices that play this type of media can collect a user's favorites or preferences list of songs, radio stations, etc., collect a user's habits (volume, station selected, etc), collect a user's preferred features (from the device), collect user's taste and listening behaviors, or create a profile based on all the information collected from the user. In a computer device such as a desktop or notebook that can also play all types of media (movies, songs, etc) and have the ability to download music, movies, and other data, such a system can collect and track all media played and generate favorites/preferences for media played (songs, movies, etc.), collect user's habits (volume, music web sites used, etc), collect user's preferred media applications, features, media, media web sites, etc., or create profiles of user's taste and listening/watching behaviors. In a vehicle such as an automotive environment, a profile and user habits can be tracked, created and stored by collecting information regarding the stations or artists listened to on a radio or CD, configurations for car temperature, seat positions, and other settings encountered in an automotive environment. With handheld devices (mobile phones, Wireless IM, PDA, etc), such devices can store and collect information related to media, UI, location, chat buddies, or other information in forming a profile based on the user behavior. Similarly, a security system or home monitoring system can control and track temperature, alarm settings and other user information that can also be used to form a profile to enhance a users experience.

Referring to FIG. 2, a high-level architecture diagram of the profile manager 30 is shown that can reside on each type of device in the framework 10 (see FIG. 1). The profile manager 30 can include a first area 32 that can include all the profile generation/interchange architecture and a second area 34 used for requesting control of the parameters of the (local) device based on the profile/information received.

The first area 32 can include a interface module 36 that abstracts all types of short range communications (Bluetooth, WLAN, Zigbee™ or IEEE 802.15.4, etc) to the rest of the profile manager, a device identifier 38 that identifies a remote device 31 and identifies the data that can be shared (not necessarily betweenjust the local device and the remote device, but amongst many or all devices in the framework 10). The first area 32 can further include an input device data filter 40 that filters and sends appropriate information (filtered to match the local device) to a profile generator 42. The profile generator 42 creates a user profile 35, habits (list) 39, favorites (list) 37, and other information that can be used in a profile. The first area 32 can also include an output device filter 46 that sends appropriate information (filtered to match the local device) to a Update module 48. The Update module 48 detects what needs to be updated (what is new to be updated on the remote device). Coupled between the profile generator 42 and the output device filter 46 and included in the first area 32 is a profile storage 44 having for a local profile 41 and an interchangeable profile 43.

The second area 34 also includes and shares with the first area 32 the interface module 36 and the Update module 48. The update module 48 in this regard can be used in controlling both the local (or local device parameter controls 49) and remote device 31 in conjunction with a decision module 47. For example, the update module 48 can update a temperature reading from the remote device 31 to the local device (or another hremote device). The decision module 47 indicates to remote device 31 and/or local device to take action (i.e., change volume settings, change temperature settings, etc.). The second area 34 can further include a temporary storage 45 that stores only the data interchanged and generally not data that is part ofthe profile (latest temperature readings, etc). The data in the temporary storage 45 generally expires (particularly if the local device did not find any other remote device that takes the temperature for example).

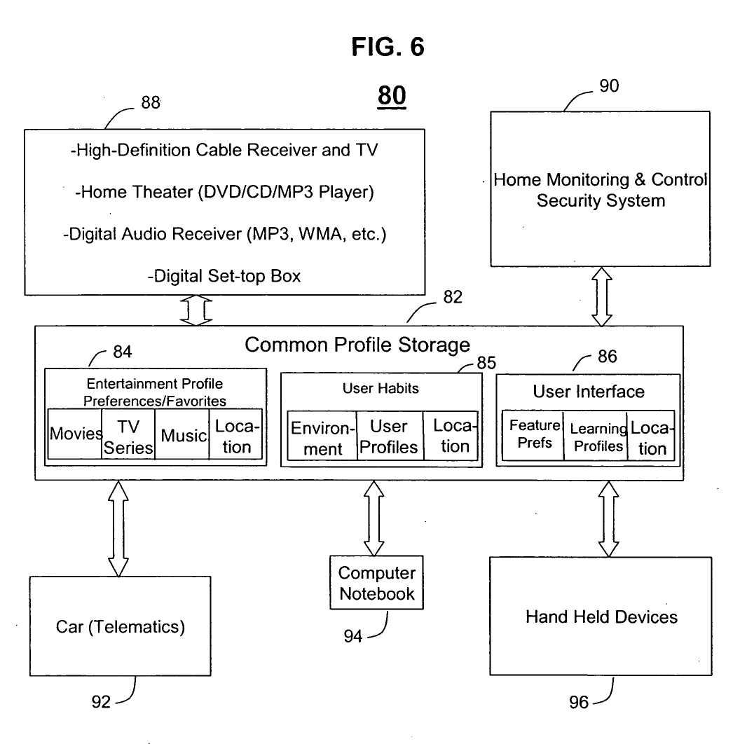

In one embodiment of the invention, all the data collected and profiles generated for each individual device in a framework 80 follow a common standard or a common virtual profile 82 as illustrated in FIG. 6. This common standard allows the devices to share the profiles among many different devices including, but not limited to home entertainment devices 88 (e.g., HD cable receiver & TV, home theater system, digital set-top box, digital audio receiver), home monitoring and control security systems 90, vehicle communication or telematic systems 92, computer devices 94, and hand held devices 96 for example. The standard format or common virtual profile 82 can have specific fields 84, 85 and 86 that store the favorites and profiles for each individual device as well as profiles coming from different devices (profiles shared among the devices). In this manner the common virtual profile 82 provides a “Seamless Learning Portability Framework” to multiple user devices to enable cooperative functioning and to enhance the overall user interface and user experience.

More specifically, each device can create user profiles based on learning occurring on its own and via interchanging parameters and profiles with other user devices. However, there are instances of user environments where multiple user devices are present. Also, using the common virtual profile 82 can alleviates the need for storing all profiles and/or parameters on all devices in this multiple device environment. In such a multiple device scenario, the common virtual profile 82 can further optimize memory utilization for storing new profiles/parameters in this new environment. The common virtual profile 82 can complement the independent profiles in each of the devices in the framework 80. Each device would not necessarily need to store a shared profile and rather each profile/parameter can be used or shared from the common virtual profile 82 when needed.

In one embodiment, each device in the framework 80 can know what device carries what information and a table can be created on each unit containing for example, what device carries what type of information, when it was created, where it was collected, and what is relevant in this environment. Each device can also aware as to what device carries a full profile or/and a partial profile. In this manner, there is no need to have any individual device serving as a master profile keeper. All the devices in the framework 80 can use this common virtual profile to have an expanded version of the profile collected/generated/used in a distributed or local fashion. In the event any of the devices are removed or moved out, an attempt can be made to update useful information (parameters/profiles) on a device in the framework 80 that has for example the most storage available, or the most capability to further update that information. In the event such an update is not possible then the entry or relevant information for a removed device can be deleted from a table that all devices can share or alternatively individually maintain.

To further illustrate an embodiment in this regard, USER A in an example use case can come home and bring with him his mobile device/devices, which can include a cell phone, a laptop, or a health monitoring accessory he has been wearing. The new home environment has (besides what he brought home) an air-conditioning system, an entertainment system, a cooking system, and other system common to a home. After multiple user devices are discovered, a common virtual profile can be created or activated. In this manner, the air-conditioning system does not necessarily need to download and locally store USER A's health information, but can rather use this information from a common virtual profile to determine and/ or assist USER A with a home temperature setting. The common virtual profile in an environment of multiple user devices can create a table on each devices with respect to what is available and where it is available and use the common virtual profile as and when needed with the further ability to change and/or update the table when any of the device moves out or is turned off or even in cases where parameters are significantly different between devices.

Note, not all the devices share the same information and not all devices necessarily care about all the information generated by other devices. But the common virtual profile allows the device to “only” read/write what is interesting or of use for each device. For example, a set top box system primarily uses or cares about viewing media and does not care about location sensitive profiles. So, a home theater system can interchange information with a mobile phone, but the information interchanged between those devices is only media favorites, media related profiles and other pertinent information of common interest between the devices. The mobile device has generated a whole lot more information that it likely not of interest to the set-top box. The devices can cooperatively build a bigger profile based on every device. The new profile created as a result will be richer since all the information created belongs to a more diverse set of devices (from a diverse set of environments).

Below are examples of tables and information that can be used in a profile (whether a virtual common profile or otherwise):

| Attribute | Description |
|---|---|
| Entry ID | Event ID |
| Type | Type associated to the entry (type of media, email, etc) |
| Action | Action performed on the type entry (play, record, edit, |
| | read, write) |
| Location | Coordinates from which the action was executed. |
| Time and Date | Time and date from which the action was executed. |
| Duration/status | Length of the event, played/recorded in full, etc. |

With the collection of above, the following information can be classified: Entertainment favorites:

| Attribute | Description | | | |
|---|---|---|---|---|
| Type | Media (Movie, songs), UI (shortcuts) | | | |
| Source | Media source: Cable, Satellite, CD, Downloaded (URL | | | |
| | of the dire is stores separately), etc. | | | |
| Genre | Media genre. | | | |
| Location | Coordinates of the favorite list | | | |
| Time and Date | Time and Date of the creation | | | |
| Last entry | Time and Date of the last entry | | | |
| List Items | Entries on the favorite lists | | | |
| User Profile | Type | Music, Movies, etc | Profile | Like, Dislike, |
| | | | | taste, etc. |

User's Habits:

| Attribute | Description | | | |
|---|---|---|---|---|
| Environment | Volume, temperature | | | |
| Preferences | | | | |
| Location | Habit Coordinates | | | |
| User Profile | Type | Media, UI, | Profile | Like/dislike/Genre |
| | | etc. | | associated with the type |
| | | | | most used items, time of |
| | | | | the most used items, etc |

User Interface:

| Attribute | Description | | | |
|---|---|---|---|---|
| Feature | Applications used, frequency, etc | | | |
| Preference | | | | |
| Learning Profile | History, UI usage. | | | |
| Location | Habit Coordinates | | | |
| User Profile | Type | Media, UI, | Profile | Like/dislike/Genre |
| | | etc. | | associated with the |
| | | | | type most used items, |
| | | | | time of the most used |
| | | | | items, etc |

From the learning in the form of collected data in tables as illustrated above, user profiles corresponding to location and time, interaction sensitive profiles are created. The information collected, , the profile generated as well as favorite lists can be interchanged upon device request.

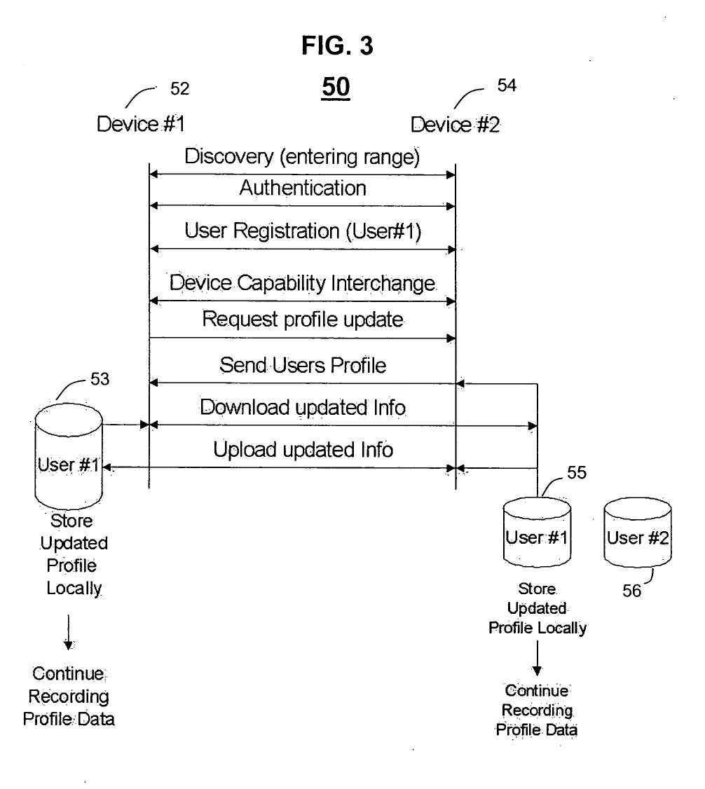

The manner in which information or profiles are interchanged is further illustrated with reference to the data flow diagram 50 of FIG. 3. The interchange can take the form of a peer to peer device profile interchange among a first device 52 having a first user profile 53 and a second device 54 having a first user profile 55 as well as an optional second user profile 56. More specifically, once the devices are within a predetermined proximity or range (using Bluetooth, WLAN, Zigbee™ or IEEE 802.15.4, etc) of each other, they are in discovery and can start interchanging information. Both devices can authenticate by interchanging the device certificates for example. After a successful authentication, the user can register since it can be a multiple user device (as illustrated with the two user profiles for the second device 54). The registration can be done automatically without user intervention. After successful registration, the devices (52 and 54) can interchange their capabilities and settings (device type, data type accepted for the device, profile type) information. The capabilities interchange is particularly useful for both devices in determining what type of profile/data to interchange. In one embodiment, once all the data is interchanged, one of the devices (in this example, device 52) takes master ownership and requests a profile from the other device 54 (time stamped profile/parameters). Once the master device (52) gets the information (parameters/profiles), the device 52 can generate difference from what is stored locally and send it to the other device 54. After all the data is downloaded successfully, the master device 52 starts sending its own profile to the other device. Once all the data is updated, then both devices can start using the new parameters/profile and can update the respective User interfaces, favorites, etc. on each of the devices.

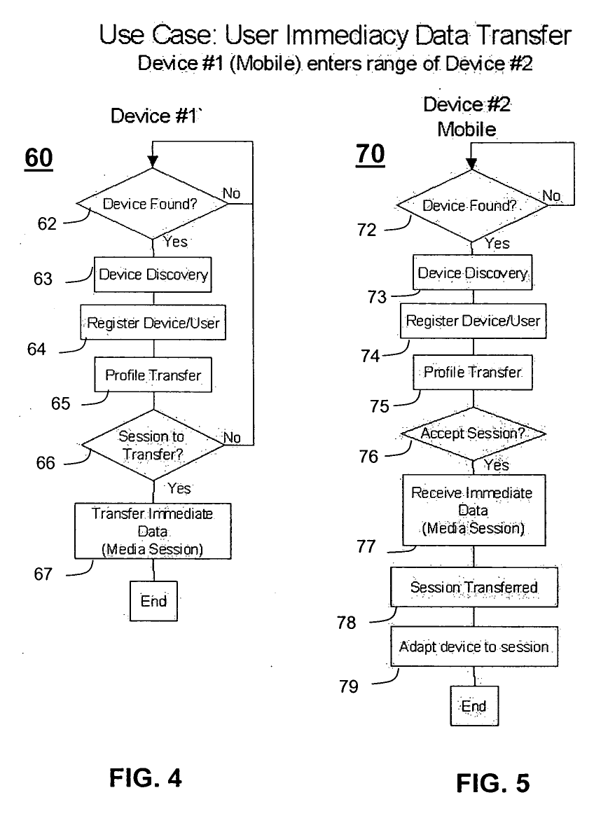

In one alternative embodiment though, the data received by each of the devices can be used to make a decision. Part of the data received can be marked as immediate which means that the device needs to act instantly on such marked data. If data is not marked immediate, then it can be stored and used to enhance the device profile. Referring to FIGS. 4 and 5, methods 60 and 70 illustrating such an interchange among devices 52 and 54 respectively are shown. In method 60 at device 52, if another device is discovered at decision block 62, then device discovery 63, registration 64, and profile transfer 65 proceeds as previously described above. At decision block 66, if there is a session transfer, then immediate data is transferred at step 67 in a media session for example. If no device is found at decision block 62 or if no session needs transferring at decision block 66, then the method continues to poll for other devices at decision block 62. Similarly at device 54, the method 70 determines if another device is discovered at decision block 72, then device discovery 73, registration 74, and profile transfer 75 proceeds as previously described above. If there is a session to transfer from the first device 52 at decision block 76 to the second device 54, then the second device 54 receives the immediate data 77 and transfers the session to the second device 54 at step 78. Subsequently, the second device 54 is adapted to the session transferred at step 79. If no device is found at decision block 72 or if no session needs transferring at decision block 76, then the method continues to poll for other devices at decision block 72.

Note, the profile interchange could take place in many different ways. In a one to one interchange, it should be noted that certain devices have multiple owners or users (TVs, set-top boxes, etc.). In such instance, then the authentication can be created for each user to enable a data interchange only when the user of the user device is present (the user must do a manual configuration on the TV before using this feature, unless the TV can automatically discover the particular user from the user device). For example, a user leaves home wearing his or her cell phone and gets into their car. The car updates all the profile, tunes the radio to the same radio station as the user was listening on the radio (either on the cell phone or on a home entertainment system), or sets up the music based on the user profile. Before leaving the house, all the devices setup the recording times for the most watched TV networks on a recording device (DVR/VCR).

In a conditional interchange, data can be interchanged as requested. For example, in an interchange profile between husband and wife profile, upon the husband and wife coming within proximity of each other, they can share the profile information stored on both handheld devices if either the husband or wife requested it. The interchange can require a manual authentication from both sides.

In a manual interchange, the user must give his/her feedback to the device before interchanging profile data. For example, when a user buys a new phone, all the information can be transferred from one phone to another where the transfer is requested manually.

There are also instances where interchange with an other device is not possible. The interchange also can be setup to be one way only. In one example, a user rents a car and once he or she gets in, the car updates the profile based on the information carried by the user, but it does not share the cars profile with the user. In another example, a user visiting their child desires to watch all their favorites sporting events. A set top box at their child's house can download all the user's profile without necessarily storing it. The child's profile (from the set-top box or from other devices at the child's home) does not necessarily get downloaded to the user's (visiting parent's) handheld device.

In a more tailored fashion, a profile can be set up so the user can control what particular information can be shared as well as what to share according to the device or user in a profile level interchange. In one example, a husband and wife coming within proximity with each other can share profile information marked as “interchangeable” on both devices.

In an open interchange, a device will not require ownership; but will accept all profiles. In an open interchange scenario, there are several levels of open authentication. In a first case, the subject device will receive all device profiles, but will not interchange the learned capabilities with other devices (e.g., handheld device approaching a rental car). For example, when a user rents a car and once he or she gets in, the car updates the profile based on the information carried by the user, but it does not share the car's profile with the user. In a second case, the subject device will receive all device profiles, but will only interchange the learned capabilities since the last time that the particular owner of the subject device registered (e.g., the user travels to the same location and wants to learn the radio stations so next time that user travels to the same location all the information can be retrieved again with minimal or no user interaction). In a third case of an open interchange, there can be a limited interchange when a user gets in range, (e.g., when the user goes to visit relatives and logs into a set top box, the user might want to share his or her profile with respect to information useful for the set top box only). For example, a user visiting his daughter and desiring to watch the all his favorite sporting events can have a set top box at his daughter's house download his profile without necessarily storing it while his daughter's profile does not get downloaded to his handheld device.

In yet another example illustrating the seamless portability aspects herein, a user using an MP3 player on a mobile device can have a play list selected and activated in a session on the mobile device. When the mobile device comes within range of a different device (e.g., a home entertainment system) that can take a similar session, then the profile is interchanged (immediate data is interchanged with the profile). The profile is stored on the second device and the immediate data is acted upon at the new or different (or second) device. The second device takes the play list (immediate data) and selects this list and starts playing the play list or the particular song that was playing on the mobile device (e.g., by searching on a CD database at the home entertainment system and selecting the songs included on the play list). The immediacy data transfer is processed with or without local device storage. It is used to transfer the information related to the session that the user is involved on (Multimedia session—play list, songs playing, etc) to keep the experience going and hopefully seamless in most embodiments. The seamless profile portability helps a user to take the same radio station, media favorites, music or other desired characteristic when going from home to the car and to the office or among other environments. Using this method, the user devices can use a diverse set of user devices and environments for building user profiles overtime. Thereby, each user device becomes capable of providing and enhanced interface and experience in different contexts.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of collectively setting preferences among at least two electronic devices; comprising the steps of:
collecting user preference data independently by the at least two electronic devices;
exchanging the user preference data among the at least two electronic devices when the at least two electronic devices are within a predetermined proximity;
forming a user profile from the user data exchanged; and
setting parameters in at least one among the at least two electronic devices in accordance with the user profile.

2. The method of claim 1, wherein the step of collecting user preference data comprises the step of collecting at least one among user content preferences, user habit preferences, user source preferences, and user device feature preferences.

3. The method of claim 2, wherein the step of collecting user preference data further comprises the step of collecting at least one among movie preferences, video series preferences, actor or actress preferences, movie producer preferences, movie studio preferences, volume preference, network preferences, user taste preferences, song preferences, radio station preferences, singer preferences, band preferences, music style preferences, web site preferences, temperature preferences, alarm setting preferences, chat buddies, and email list preferences.

4. The method of claim 1, wherein the method further comprises the step of authenticating the at least two electronic devices before the step of exchanging the user preference data.

5. The method of claim 1, wherein the method further comprises the step of user registration.

6. The method of claim 1, wherein the method further comprises the step of interchanging capabilities and settings among the at least two devices.

7. The method of claim 1, wherein the method further comprises the step of forming a master and slave relationship among the at least two electronic devices to enable a master device among the at least two electronic devices to request and receive a profile from a slave device among the at least two electronic devices.

8. The method of claim 7, wherein the method further comprises the step of determining a difference in user preferences and settings between the master device and the slave device and sending the difference to the slave device.

9. The method of claim 1, wherein the step of forming a user profile comprises the step of creating a common virtual profile for the at least two electronic devices containing a table having information regarding which devices handle a type of information, when the information was created, where the information was stored, and what information is relevant in a current environment in view of resources available.

10. The method of claim 9, wherein the method further comprises the step of maintaining information regarding which among the at least two electronic devices contains a full version of the common virtual profile and a partial version of the common virtual profile.

11. The method of claim 1, wherein the step of setting parameters comprises the step of setting parameters in each of the at least two electronic devices in accordance with the user profile.

12. A profile manager used in an electronic device, comprising:
an interface module for abstracting data to a remaining portion of the profile manager;
a device identifier coupled to the interface module, wherein the device identifier identifies a remote device and identifies data that can be shared between the electronic device and the remote device;
a profile generator coupled to the device identifier for creating a user profile based on user interactions with the electronic device;
a storage medium for storing the user profile including a local profile and a interchangeable profile; and
an update engine for detecting what needs to be updated on at least one among the electronic device and the remote device.

13. The profile manager of claim 12, wherein the profile manager further comprises an input device filter coupled between the device identifier and the profile generator for filtering data to match data recognizable by the electronic device.

14. The profile manager of claim 12, wherein the profile manager further comprises an output device filter coupled between the storage medium and update engine for filtering data to match data recognizable by the remote device.

15. The profile manager of claim 12, wherein the profile manager further comprises a decision engine coupled to the update engine for directing at least one among the electronic device and the remote device to alter at least one setting in accordance with the update engine.

16. The profile manager of claim 12, wherein the profile generator creates a common virtual profile for the electronic device, the remote device, and any other remote device using the common virtual profile, wherein the common virtual profile contains a table having information regarding which devices handle a type of information, when the information was created, where the information was stored, and what information is relevant in a current environment in view of resources available.

17. A machine readable storage, having stored thereon a computer program having a plurality of code sections executable by a machine for causing the machine to perform the steps of:
collecting user preference data independently by the machine;
exchanging the user preference data among the machine and a remote electronic device comprising at least two electronic devices when the at least two electronic devices are within a predetermined proximity;
forming a user profile from the user data exchanged; and
setting parameters in at least one among the at least two electronic devices in accordance with the user profile.

18. The machine readable storage of claim 17, wherein the computer program further has a plurality of code sections executable by the machine for causing the machine to perform the steps of authenticating the at least two electronic devices before the step of exchanging the user preference data, registering a user of the at lest two electronic devices, and interchanging capabilities and settings among the at least two electronic devices.

19. The machine readable storage of claim 17, wherein the computer program further has a plurality of code sections executable by the machine for causing the machine to perform the step of forming a master and slave relationship among the at least two electronic devices to enable a master device among the at least two electronic devices to request and receive a profile from a slave device among the at least two electronic devices.

20. The machine readable storage of claim 17, wherein the computer program further has a plurality of code sections executable by the machine for causing the machine to perform the steps of creating a common virtual profile for the at least two electronic devices containing a table having information regarding which devices handle a type of information, when the information was created, where the information was stored, and what information is relevant in a current environment in view of resources available.
